(19) United States
(12) Patent Application Publication
(10) Pub. No.: US 2012/0328999 A1
(43) Pub. Date: Dec. 27, 2012

(54) DEVICE AND A METHOD FOR MANAGING UNBURNED RESIDUES IN REGENERATIVE BURNERS, A BURNER INCLUDING SUCH A DEVICE

(75) Inventors: Yves BRAUD, DAMVIX (FR); Ludovic FERRAND, SAINT-GERMAIN-EN-LAYE (FR); Luc MALPAS, LIERS (BE)

(73) Assignee: COCKERILL MAINTENANCE & INGENIERIE SA, SERAING (BE)

(21) Appl. No.: 13/535,160

(22) Filed: Jun. 27, 2012

(30) Foreign Application Priority Data
Jun. 27, 2011 (FR) 1155701

(51) Int. Cl. F28G 1/16; F28D 17/00; F27D 17/00

(52) U.S. Cl. 432/2; 432/180; 432/75; 432/41; 165/5

(57) ABSTRACT

A device for managing unburned residues, the device comprising a regenerator (5) having one end connected to a combustion enclosure (3) and an opposite end connected to a fuel admission pipe (4) and a flue gas exhaust pipe (8), the pipes being fitted with valves (2; 10) to alternate between an admission stage and an exhaust stage through the regenerator. A purge circuit (1) connected to the regenerator (5) acts before the exhaust stage to purge the regenerator of the fuel that it contains. The invention provides a corresponding method of managing unburned residues and a burner including such a device.

### FIELD OF THE INVENTION

The present invention relates to a device and a method for managing unburned residues in circuits that implement a regenerator. The device and the method are intended in particular for use in regenerating blast furnace gas. The invention also provides a regenerative burner including such a device.

### BACKGROUND OF THE INVENTION

Regenerative systems are known that serve to preheat a gas having low calorific value in order to increase flame temperature. This makes it possible to reach a temperature that is sufficient to enable the gas to be used in an industrial process. Such systems make it possible to recover heat from gases that are lean, such as blast furnace gas that is produced as a by-product of steel-making. This presents two advantages: lowering the energy bill of the steel works; and avoiding the need to reject the gas directly into the atmosphere, where such gas often has a negative environmental impact.

In a conventional regenerative system, two burners are paired and operate in a cycle that alternates between an admission stage and an exhaust stage. For this purpose, each burner is associated with fuel and oxidizer admission ducts and with a flue gas exhaust duct. Valves control the opening of the ducts so that each burner cyclically alternates between a combustion function in which a mixture of fuel and oxidizer (usually air) is injected into the burner where it is burnt, and an exhaust function in which the then-inactive burner merely has combustion gas passing therethrough. Each burner is fitted with a regenerator that performs a heat storage function by:
preheating the fuel that passes through it by yielding heat thereto during the admission stage; and
absorbing heat from the exhaust gas that passes through it during the exhaust stage.

Furnaces that implement lean gas regenerative systems nevertheless emit discharges that are relatively polluting, such that they are used for the most part in Asia where environmental legislation allows such polluting discharges. Post-combustion systems of the flare type or treating the flue gas prior to rejecting it to the atmosphere enable the level of pollution associated with the discharges to be controlled, but they also have a non-negligible impact on the environment and they have operating costs that are particularly high (in terms of investment, and down-time for an entire production unit during installation and maintenance of such equipment).

### Object and Summary of the Invention

An object of the invention is to provide means that are simple and inexpensive for limiting the pollution generated by installations having regenerative systems.

It has been observed that cyclic operation gives rise to unburned fuel contained in the regenerator being discharged together with the exhaust gas, and that this discharge contributes very considerably to the pollution generated by furnaces having regenerative systems.

The invention seeks to purge the regenerator of the fuel that it contains prior to the exhaust stage and thus to avoid discharging the fuel to the atmosphere. This solution is an affordable alternative to expensive post-combustion or discharge treatment devices.

To this end, the invention provides a device for managing unburned residues, the device comprising a regenerator having one end connected to a combustion enclosure and an opposite end connected to a fuel admission pipe and to a flue gas exhaust pipe. The pipes are provided with valves for alternating between an admission stage and an exhaust stage through the regenerator, and the device includes a purge circuit connected to the regenerator and arranged to purge it of the fuel it contains prior to the exhaust stage.

According to the invention, the purge circuit is arranged also to purge a fuel admission pipe and it includes suction-generator means.

In this way, the substances discharged during the exhaust stage do not include the fuel residue that was contained in the regenerator or in the admission pipe after the admission stage that preceded the exhaust stage under consideration. The purge circuit may be connected directly to the regenerator or to any pipe that is connected thereto and that is capable of being isolated from the network, e.g. by a system of valves. This flexibility enables such a system to be installed easily in an already-existing installation and enables it to accommodate the constructional constraints of equipment that is already in place.

Advantageously, the fuel contained in the regenerator is directed to the combustion chamber so as to be burnt therein.

This ensures that all of the admitted fuel is burnt, with a purge circuit that is short, simple, and easy to install.

Ideally, the combustion enclosure is that of a reheating furnace used in the operation of the steel works.

The low cost of fabricating and installing such equipment, its suitability for being implemented on an existing installation with only short down-time of its equipment, and the immediate improvement it provides to the energy efficiency and the environmental impact of burners that are fitted therewith make this alternative to flares and flue gas treatment systems particularly attractive.

The invention also provides a method of managing unburned residues by means of a device of the above-specified type.

Finally, the invention provides a regenerative burner including a device of the above-specified type.

### BRIEF DESCRIPTION OF THE DRAWINGS

Other characteristics and advantages of the invention appear on reading the following description of particular, non-limiting embodiments of the invention.

Reference is made to the accompanying drawing, in which:

FIG. 1 is a view of a system of paired regenerative burners, not fitted with the invention; and

FIG. 2 is a view of a regenerative burner fitted with the invention.

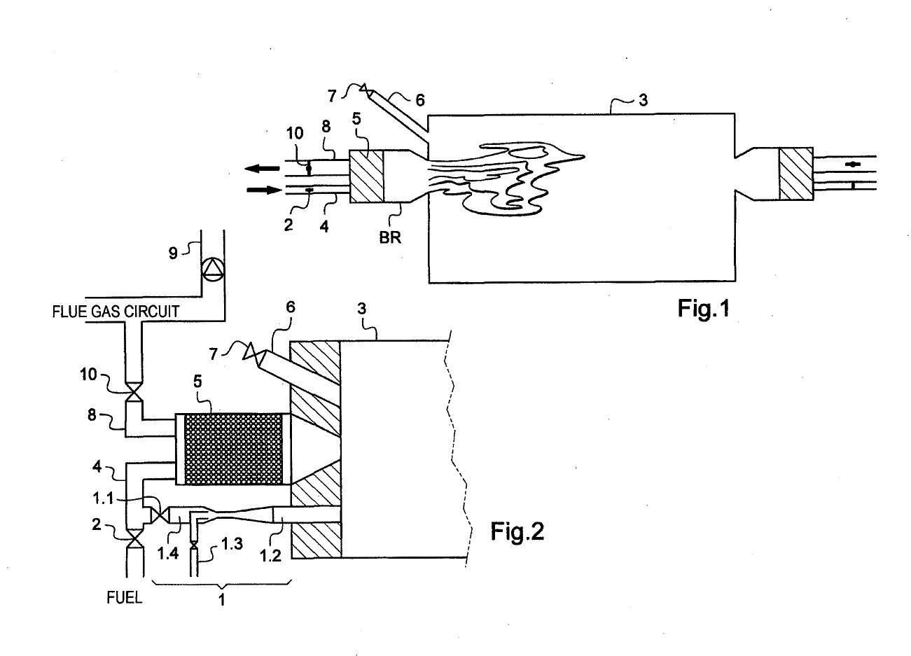

### MORE DETAILED DESCRIPTION

In this example, the device for managing unburned residues is installed on a regenerative burner given overall reference BR for preheating blast furnace gas.

The regenerative burner BR has a regenerator 5 having one end connected to a fuel feed pipe 4 which is opened under the control of an admission valve 2, to an exhaust circuit 8 that is opened under the control of an exhaust valve 10, and an opposite end leading into a combustion chamber 3.

The combustion chamber 3 is fed with oxidizer (air in this example) via a combustion air feed pipe 6 controlled by a feed valve 7. An exhaust duct 8 leads from the regenerator 5 to the combustion gas rejection circuit 9 with access thereto being controlled by the exhaust valve 10.

According to its general operating principle, the burner alternates between an admission stage and an exhaust stage. During an admission stage, the regenerator 5 yields heat to the fuel so that the enclosure receives combustion air and heated fuel that is burnt within the enclosure. During the exhaust stage, once the fuel present in the enclosure has burnt, the regenerator 5 passes the flue gases that result from the combustion and that yield heat to the regenerator 5 prior to being exhausted into the exhaust circuit 8. The admission stage can then be restarted and the cycle continued.

A purge circuit given overall reference 1 is installed in this example downstream from the fuel admission valve 2. It comprises the following elements:
a purge circuit inlet valve 1.1;
a pipe 1.2 fitted with a gas ejector 1.3; and
an end-of-purge sensor 1.4, in the form of a temperature sensor in this example.

The purge circuit 1 connects together the combustion enclosure 3 and, downstream from the fuel admission valve 2, the admission pipe 4. As explained below, this arrangement enables the regenerative burner BR to be purged in full (both the regenerator 5 and the fuel admission pipe 4), and not only the regenerator 5.

The operation of the burner and of the purge circuit are described below in greater detail.

The operating cycle of the regenerative burner begins with an admission stage. In the initial state, the admission, exhaust, combustion air feed, and purge circuit inlet valve 2, 10, 7, and 1.1 are all closed. The fuel admission valve 2 is open, filling the admission pipe 4, the regenerator 5, and feeding the combustion enclosure 3. While the combustion enclosure 3 is being fed with a determined quantity of fuel, the feed valve 7 is open and supplies the required volume of combustion air via the combustion air feed pipe 6. Once the required quantities of air and fuel have been admitted into the combustion enclosure 3, the valves 2 and 7 are closed. At this point all of the valves of the system are in a closed state. It should be observed that since combustion takes place in the enclosure 3, the fuel contained in the fuel pipe 4 and also the fuel contained in the regenerator 5 is not burnt.

Once combustion has been completed, the regenerative burner passes via the purge stage. The purge circuit inlet valve 1.1 is opened. The gas ejector 1.3 is put into operation. The fluids (fuel and flue gases) upstream therefrom are sucked along and directed to the combustion enclosure 3 via the pipe 1.2. The fuel present in the regenerator 5 and in the admission pipe 4 is sucked out and replaced by the combustion gas coming from the enclosure 3. The fuel admitted into the enclosure 3 burns during the combustion stage of the paired burner. The combustion air needed for burning the fuel purged from the circuit may be provided by the duct 6 or by the gas ejector 1.3. Once the temperature sensor 1.4 indicates a lasting rise in temperature representing the permanent presence of a stream of flue gas, that means that the regenerator 5 and the pipe 4 have been purged of the fuel they had retained.

The exhaust stage can then begin: the purge circuit inlet valve 1.1 is closed and the exhaust valve 10 is opened. Since the combustion gas ejection circuit 9 is at reduced pressure, the flue gas present in the feed duct 4, the regenerator 5, the combustion enclosure 3, and the exhaust duct 8 is sucked to the outside.

A new admission cycle can then begin.

Thus, the fuel present in the regenerator 5 and the admission pipe 4 and the end of the combustion stage has not been rejected to the exhaust.

Naturally, the invention is not limited to the embodiments described but covers any variant coming within the ambit of the invention as defined by the claims.

In particular:
emptying may be performed with the help of a gas ejector 1.3, a circulation fan, or any other suction-generator means;
the purge circuit 1 may feed: an independent circuit for conveying fuel, another combustion chamber, another regenerator;
the fuel may be a gas, a liquid in suspension, a combustion effluent;
the end-of-purge sensor 1.4 may be a sensor for sensing temperature, humidity, pressure, resistivity, or any other parameter enabling fuel to be identified;
the end-of-purge sensor 1.4 may be implanted directly in the regenerator, at any point of the purge circuit, or of the exhaust or feed pipe;
the devices controlling admission, exhaust, connection of the purge circuit, and admission of combustion air may be valves, cocks, dampers, injectors, slides, or any other means for controlling a fluid stream; and
the purge circuit may be implanted at any point in the exhaust or admission pipe or it may be directly connected to the regenerator.

What is claimed is:

1. A device for managing unburned residues, the device comprising a regenerator (5) having one end connected to a combustion enclosure (3) and an opposite end connected to a fuel admission pipe (4) and a flue gas exhaust pipe (8), the pipes being fitted with valves (2; 10) to alternate between an admission stage and an exhaust stage through the regenerator, the device also comprising a purge circuit (1) connected to the regenerator (5) to purge it of the fuel it contains prior to the exhaust stage, wherein said purge circuit (1) is arranged also to purge a fuel admission pipe (4) and wherein it includes suction-generator means.

2. A device according to claim 1, wherein the purge circuit (1) includes a gas ejector (1.3).

3. A device according to claim 1, wherein the purge circuit (1) includes a circulation fan.

4. A device according to claim 1, wherein the purge circuit (1) includes an inlet connected to the downstream end of the fuel admission valve (2).

5. A device according to claim 1, wherein the purge circuit (1) includes an inlet connected to the upstream end of the exhaust valve (10).

6. A device according to claim 1, wherein the purge circuit (1) is arranged to direct the purged fuel to a combustion chamber (3).

7. A device according to claim 1, having a sensor (1.4) arranged to detect when all of the fuel has been purged from the regenerator (5).

8. A device according to claim 7, wherein the sensor (1.4) is a temperature sensor.

9. A method of managing unburned residues by means of a device comprising a regenerator (5) having one end connected to a combustion enclosure (3) and an opposite end connected to a fuel admission pipe (4) and a flue gas exhaust pipe (8), the pipes being fitted with valves (2; 10) to alternate between an admission stage and an exhaust stage through a regenerator (5), the method comprising the step of purging a regenerator (5) of the fuel that it contains prior to the exhaust stage.

10. A met hod according to claim 9, wherein the regenerator (5) is purged by transferring the fuel to the combustion enclosure (3).

11. A method according to claim 9, wherein the regenerator (5) is purged by transferring the fuel to another circuit for conveying fuel.

12. A method according to claim 9, wherein at least a portion of the fuel admission duct is also purged.

13. A regenerative burner provided with a device in accordance with claim 1.
